(19) United States
(12) Patent Application Publication
(10) Pub. No.: US 2010/0124939 A1
(43) Pub. Date: May 20, 2010

(54) METHOD AND SYSTEM FOR GRAPHICAL SCALING AND CONTEXTUAL DELIVERY TO MOBILE DEVICES

(76) Inventors: John Osborne, Incline Village, NV (US); James H. Schmidt, Incline Village, NV (US)

Correspondence Address: IAN F. BURNS & ASSOCIATES, 4790 Caughlin Parkway #701, RENO, NV, 89519-0907, US

(21) Appl. No.: 12/620,859

(22) Filed: Nov. 18, 2009

Related U.S. Application Data
(60) Provisional application No. 61/116,231, filed on Nov. 19, 2008.

(51) Int. Cl. H04W 4/12; G06F 15/16

(52) U.S. Cl. 455/466; 709/219; 709/206

(57) ABSTRACT

Methods for scaling graphical constructs comprised of graphical images, text, and photographic images are disclosed. In mobile devices, each device could have different screen resolution, orientation, and color palette capabilities. When a graphical page, such as a greeting card, is sent from a sender device to a recipient device, a server determines the display characteristics of the recipient device and delivers either a pre-computed graphics page corresponding to the device's display requirements or generates the proper display on the fly. Additional information, such as location or images from the sender device can be uploaded to the server to be properly scaled and positioned to complete the graphical page in a context tailored to the recipient.

### CROSS REFERENCE TO RELATED APPLICATIONS

This application claims priority to U.S. provisional patent application Ser. No. 61/116,231, filed Nov. 19, 2008, the contents of which is herein incorporated by reference.

### FIELD OF THE INVENTION

The present invention relates generally to the fields of computer systems and data processing, wireless telecommunications, and in particular to scaling graphical constructs and selecting the proper scaling page based on display requirements.

### BACKGROUND

Hand-held computer devices and in particular mobile phones are becoming more capable, handling more diverse forms of multimedia data all the time. Applications built on these new capabilities are also exploding in number and functionality. These myriad devices, however, all have different screen sizes, orientations (often different orientation on the same device), and color spaces, making it difficult to deliver content to the device in a manner devoid of defects to provide a display that is also pleasing to the eye.

In Mariott, et al. (U.S. Pat. No. 7,433,546) a system is disclosed which allows a server to store different sizes of photographic images so that the image corresponding to the proper screen parameters is delivered. While this invention utilizes screen capability information transmitted to the server in the request, it does not specifically handle the on-the-fly scaling of graphical data such as greeting cards, in which the graphical elements of the card and text must be scaled effectively to match the screen size.

In Wu, et al. (U.S. Pat. No. 7,398,478) and Challa (U.S. Pat. No. 7,436,412) graphic scaling systems of various types are presented but these algorithms do not represent the full challenge of delivering scaled content over a low bandwidth communications channel with selectivity to match the display's characteristics.

In Hawley, et al. (U.S. Pat. No. 7,418,696) a system is disclosed where the target device receives statements directing it to render a business form so that it matches the display's requirements, but this strategy burdens an already complex target device processor and is not generic to graphical display for which it may not have a template.

None of the above examples of prior art allow for the transfer of contextual, personal, or location data to the server to render unique displays to individual users.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to render message content to match the display characteristics of a recipient device;

provide a system allowing a sender of a message to generate content for the message without regard to the display characteristics of a recipient device;

provide a system for sending of personalized messages such as greeting cards, post cards and the like;

generate message content based on message templates from a server; and

generate message content based on a sender's location.

These and other advantages may be realized by reference to the remaining portions of the specification, claims, and abstract.

### BRIEF DESCRIPTION OF ONE EMBODIMENT OF THE PRESENT INVENTION

In one aspect, the invention provides a method for communicating content to a recipient on a mobile telecommunications network. A server may provide a notification to at least one recipient device. The recipient device may acknowledge the notification by identifying one or more display characteristics of the recipient device. Message content of the message may be formatted at the server based on the display characteristics of the recipient device and then provided to the recipient device.

In one aspect, the invention provides a mobile telecommunications system comprising a server and a recipient application executable on a recipient mobile device. The server may be configured to notify the at least one recipient mobile device of a message. In response to a notification, the recipient application may indicate display parameters of the recipient mobile device, allowing the server to render a message to the display parameters of the recipient mobile device and provide the rendered message to the recipient mobile device.

In one aspect, the invention provides a method for delivering a personalized message or the like to a mobile communications device. A personalized message template selection may be received from a sender device as well as an indication of one or more recipient mobile devices. A personalized message may be created from the selected personalized message template. In response to a message notification, an indicated recipient device may indicate display parameters of the recipient device so that the personalized message may be rendered to the display parameters of the recipient device.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of a system for providing messages to mobile devices;

FIG. 2 is substantially a flowchart of a method for providing messages to mobile devices;

FIG. 3 is substantially a flowchart of a method for generating and delivering message content; and

FIG. 4 substantially shows an example of generating and delivery a personalized message resembling a post card.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The general purpose of the present invention, which will be described subsequently in greater detail, is to provide a method whereby a graphical page display may be rendered by pre-computation or on-the-fly to a variety of formats. The graphical page display may be comprised of many elements, including but not limited to graphics, photo images, text, clip art, etc.

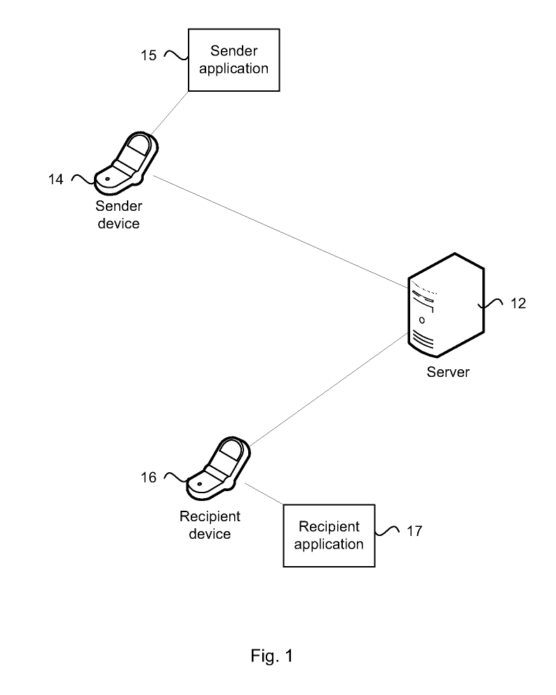

A system in accordance with one embodiment of the invention is illustrated in FIG. 1. The system 10 includes a server 12 that provides telecommunication services between a sender device 14 and a recipient device 16. The server 12 may be configured to provide content services to the recipient device 16. The server 12 may be a core component of a telecommunications network and it will be understood that while only a single sender device 14 and a single recipient device 16 is shown, the server 12 may provide telecommunications services between many senders and recipients. The server 12 may be configured to provide telecommunications services using any known wireless protocol.

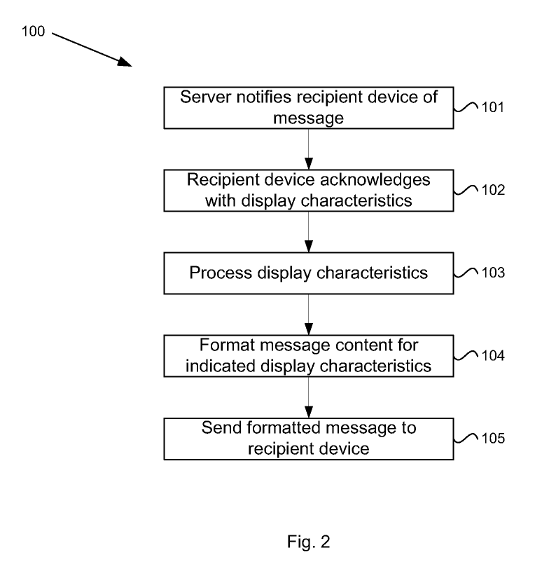

In one embodiment, the recipient device executes an application, e.g., a recipient application 17, that allows the recipient device 16 to receive content laden messages. A method for providing messages to the recipient device 16 is illustrated in the flowchart 100 of FIG. 2. At step 101, the server 12 notifies the recipient device 16 that a message has been addressed to the recipient device. The notification may indicate various aspects of the message, such as a title of the message, size of the message, types of content that the message includes (text, images, video, etc), or an indication of an application used to create the message. The recipient device may respond with an acknowledgement (step 102) that notifies the server that the message can be transmitted. The acknowledgement may be provided with recipient consent, i.e., the recipient agrees to receive the message and takes a user action, such as selection of a key on the device keypad (not shown), to indicate the agreement. Where the recipient device 16 provides a positive acknowledgement to the notification, the recipient application 17 may be configured to indicate one or more display characteristics of the recipient device 16. The display characteristics may be specific display characteristics such as a screen size, orientation, resolution, color palette, etc as well as any specific user settings. Alternatively or in addition, the application may be configured to indicate a type of the recipient device. At step 103, the server 12 receives the acknowledgement and processes the indication of the display characteristics. If the display characteristics have been indicated by device type, the server 12 can determine the actual display characteristics by reference to a local or remotely stored look up table that correlates device type with the default display characteristics of the respective device. The server 12 can then format the message content to a format that best fits the indicated display parameters of the recipient device (step 104). Once formatted, the formatted message is then transmitted to the recipient device (step 105).

In one embodiment, different stretching and scaling algorithms can be applied by the server 12 to any images, video, etc. based on the characteristics of the page to be rendered and the device to which the content will be provided. A page consisting of mostly text, for example, could be rendered differently than one consisting of graphical and image data. In addition, text may be rendered at different sizes, not just photographically scaled, which results in a loss of information. Known methods such as maintaining the aspect ratio of an image may also be employed.

As shown in FIG. 1, the system 10 may also include a sender application 15 that executes on the sender device 14. The sender application allows the sender to generate content for transmitting to one or more recipients via the server 12. The content generated by the sender may be text or images from the sender device.

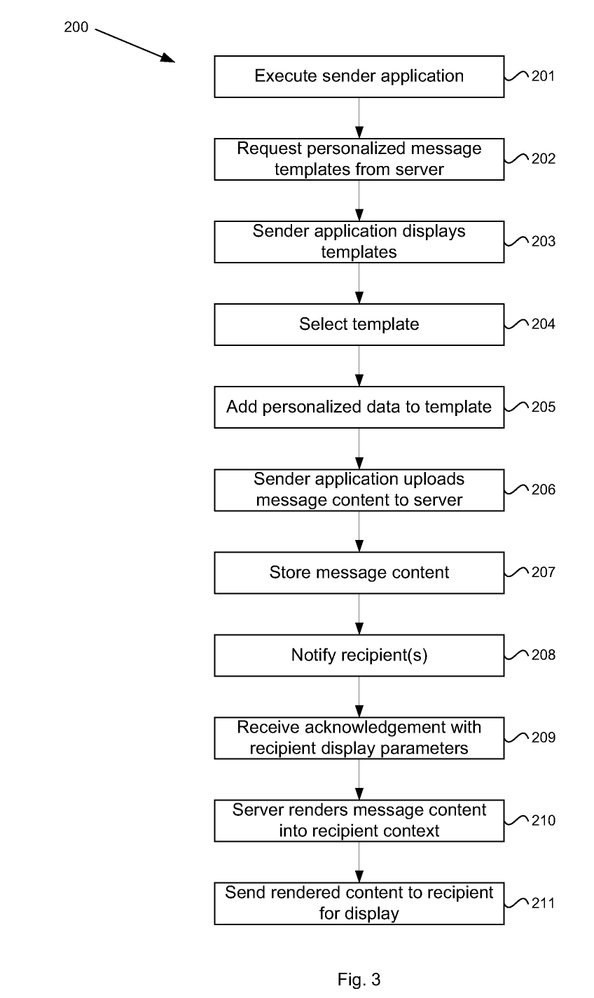

In another embodiment, content messages resembling personalized message cards, e.g., greeting cards, post cards, birthday cards, and the like may be generated using the sender application 15 in conjunction with the server 12. A process for generating content is shown in the flowchart 200 of FIG. 3. At step 201, the sender application 15 executes on the sender device 14 allowing the sender to request personalized message templates from the server 12 (step 202) via an internet, wireless protocol or other network connection. As part of this request, the sender application 15 may send the screen display characteristics of the sender device 14. The server 12 utilizes the display information to select pre-computed renderings of thumbnail images and templates that allow display of multiple thumbnails on the sender device 14 (step 203) for selection.

The user may then configure a personalized message by selecting a greeting card or other template desired as well as any of the thumbnail image (step 204). At step 205, the sender may add data to the personalized message. For example, text may be entered using the keypad of the sender device 14 or by selecting pre-configured text templates from a local memory of the sender device 14. Photos, video or other graphic content may be selected from a camera memory or other image memory of the sender device 14. This data can then be added into the graphic being generated after being scaled and properly positioned. The template and thumbnail selection and any additional data is then uploaded by the sender application 15 from the sender device 14 to the server 12 (step 206). The server 12 stores the data in its original format (step 207), and may precompute different scaling or color space modifications to the originals. When the personalized message is uploaded, the sender also indicates one or more recipients of the personalized message. A notification may be sent to the recipient(s) (step 208) by sending a greeting message, or a text equivalent which can be displayed on the recipient device to indicate the personalized message is available. When the recipient(s) acknowledges the receipt (step 209), the recipient application 17 on the recipient device(s) 16 may then transmit the screen requirements of the recipient's device to the server 12, whereupon the server 12 renders the original images, text, and templates into a unique context (step 210). Rendering the message content may include selecting the optimal image of the indicated thumbnail, scaling any images provided by the sender, resizing text, etc. The rendered content is sent to the recipient device 16 (step 211) where it can be optimally displayed on the recipient's device 16 by the recipient application 17.

In one embodiment, the sender application may also send location information regarding the sender device, e.g., from a GPS of the sender device 14, to the server 12. Using the location information, the server 12 may select location based content as appropriate templates and/or thumbnail images which may be suggested to the sender for generating the personalized message content, for example, where the personalized message from the sender is to resemble a postcard of the sender's travels. Other location specific content, such as text describing the location, can also be rendered into the display for the sender to approve, amend and/or configure.

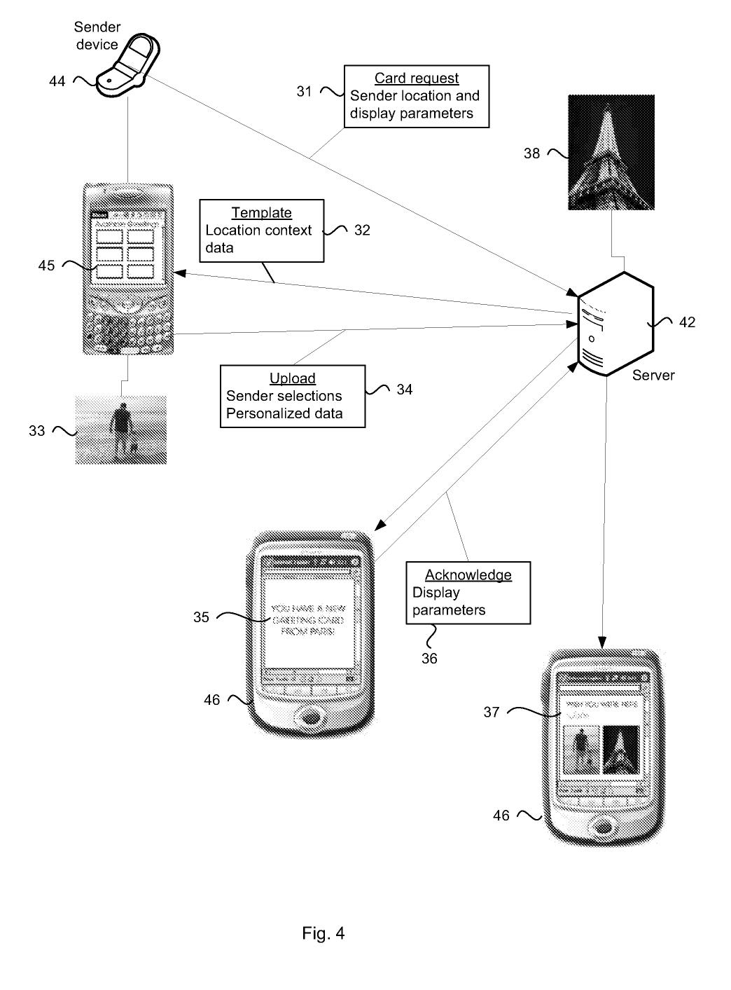

A specific example will now be described with reference to FIG. 4. In this example, a sender with sender device 44 is holidaying in Paris. The sender wishes to send greeting messages resembling a post card and so sends a request 31 to the greeting message server 42 using the greeting card application 45 that is executing on the sender device 44. The request 31 to the server 42 includes a card request that identifies the sender's location as well as the display characteristics of the sender device 44. The message server 42 process the request 31 and determines from the request 31 that the sender is in Paris. The server 42 thus selects a number of location dependent thumbnail images 38, e.g., pertaining to Paris, or France, or with French themes, renders them according to the display settings of the sender device 44 indicated in the request, and transmits the thumbnail images to the sender device 44 in the form of postcard templates 32. The sender device application 45 displays the templates allowing the sender to select a template as well as to add content such as a photo 33 from the sender device memory. The sender may also add text for the postcard. In this example, the sender adds the text “Wish you were here—John”. The sender application 45 uploads the content 34, including an indication of the selected thumbnail image (the full image may be retained at the server 42), the photo 33, the added text and the identity of one or more recipients to the server 42. The server 42 stores the data and sends a text notification 35 to the indicated recipient device 46 specifying “You have a new greeting card from Paris”. The recipient application 47 receives the text notification and displays it to the recipient. If the recipient chooses to positively acknowledge the text notification 35, the recipient application 47 sends the display characteristics 36 of the recipient device 46 to the server 42. The server 42 then retrieves the message content, renders it for the recipient device 46, and transmits it to the recipient device 46. Upon receipt of the rendered message content, the recipient application displays the postcard 37 on the display of the recipient device 46.

While the sender application is described separately to the recipient application, in one embodiment, a single application may be provided that is configured to provide the functions of both the sender application and the recipient application.

The embodiments described herein allow for the transfer of contextual, personal, or location data to the server to render unique displays to individual users. It is worth noting, that in the various embodiments the user may not be requesting Internet published data, e.g., a web page, but may access data using wireless internet protocols in order to view data specifically rendered for an application. The content is not sent as internet data, e.g., in a web page format and is not typically configured for display using a generic web browser. The sender and recipient applications may be non-browser applications that display the received content. That is, the recipient application does not merely display data referenced by URL. Rather, the recipient application displays a multimedia message with content tailored to the particular display characteristics of the recipient device. In various embodiments of the invention, the content is not transmitted as web page data, but may be transmitted in other formats, such as in a multimedia message (MMS).

An advantage of the presently described embodiments includes that the content is delivered to an application resident on the recipient mobile device without user interaction or knowledge of the process. That is, the user (in particular the recipient) is not required to make selections about formatting of the content. The images and content scaling and rendering are executed at the server, which reduces the requirements on the limited processing abilities of either the sender or recipient devices. The resultant data is compressed and scaled and is delivered not to a generic browser but is interpreted by an application running on the mobile device in order to complete the display of the information. A further advantage is that the user is specifically insulated from the tasks performed to match the display to a particular device. The sender does not need to be concern themselves with choosing content for specific recipients and the recipients can safely accept content messages knowing that the content will be rendered accurately for their particular device.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for communicating content from a sender to a recipient on a mobile telecommunications network comprising:
(A) receiving content from a sender device at a server;
(B) providing a notification to at least one recipient device;
(C) receiving an acknowledgement from the at least one recipient device, the acknowledgement identifying one or more display characteristics of the at least one recipient device;
(D) at the server, formatting the content from the sender dependent on the display characteristics received from the at least one recipient device; and
(E) providing the formatted content to the at least one recipient device.

2. The method according to claim 1 wherein receiving content comprises receiving at least one image from the sender device.

3. The method according to claim 1 comprising providing a plurality of content templates to the sender device.

4. The method according to claim 3 wherein receiving content from the sender device comprises receiving an indication of a content template selection.

5. A mobile telecommunications system comprising:
(A) a server;
(B) a recipient application executable on a recipient mobile device;
(C) wherein the server is configured to notify the at least one recipient mobile device of a message;
(D) wherein the recipient application is configured to receive the notification and respond to the notification with an acknowledgement indicating one or more display parameters of the recipient mobile device; and
(E) wherein the server is configured to respond to the acknowledgement by rendering the message to the display parameters of the recipient mobile device and provide the rendered message to the recipient mobile device.

6. The mobile telecommunications system according to claim 5 wherein the recipient application is configured to receive the rendered message and display the rendered message on a display of the recipient mobile device.

7. The mobile telecommunications system according to claim 5 comprising a sender application executable on a sender mobile device, wherein the sender application is configured to provide a message comprising message content and an indication of at least one recipient to the server, wherein the server is configured to notify the recipient mobile device in response to receiving the message from the sender mobile device.

8. A method for delivering content to a recipient mobile communications device comprising:
(A) providing a message notification to the recipient mobile communications device, the message notification indicating a message;
(B) receiving an acknowledgement from the recipient mobile communications device, the acknowledgement indicating one or more display characteristics of the recipient mobile communications device;
(C) formatting the message in accordance with the one or more display characteristics; and
(D) transmitting the formatted message to the recipient mobile communications device.

9. A server configured to communicate a multimedia message from a sender to a recipient, the server configured to:
(A) provide a message notification to a recipient device, the message notification indicating a message;
(B) receive an acknowledgement from the recipient device, the acknowledgement indicating one or more display characteristics of the recipient device;
(C) format the message in accordance with the one or more display characteristics; and
(D) transmit the formatted message to the recipient device.

10. The server according to claim 9 configured to receive the message from a mobile communications device of the sender.

11. A method for delivering a personalized message or the like to a mobile communications device comprising:
(A) receiving a personalized message request from a sender device,
(B) providing one or more personalized message templates to the sender device;
(C) receiving a personalized message template selection from the sender device;
(D) receiving an indication of one or more recipient mobile devices;
(E) creating the personalized message from the selected personalized message template;
(F) notifying at least one indicated recipient mobile device of the personalized message;
(G) receiving an indication from the at least one indicated recipient mobile device of one or more display parameters of the at least one indicated recipient mobile device;
(H) rendering the personalized message to the display parameters of the at least one indicated recipient mobile device; and
(I) delivering a rendered personalized message to the at least one indicated recipient mobile device.

12. The method according to claim 11 comprising:
(A) receiving display data from the sender device;
(B) incorporating the display data into the personalized message.

13. The method according to claim 12 wherein the display data comprises a location of the user.

14. The method according to claim 12 wherein the display data comprises an image provided from the sender device.

15. The method according to claim 11 wherein one or more personalized message templates comprises a template image.

16. The method according to claim 15 comprising formatting the template image to the device parameters indicated for the at least one indicated recipient device.

17. The method according to claim 15 wherein the personalized message request comprises a location of the sender device, wherein the personalized message templates provided to the sender device are selected dependent on a location indicated by the sender device.
